(19) United States
(12) Patent Application Publication
(10) Pub. No.: US 2019/0228569 A1
(43) Pub. Date: Jul. 25, 2019

(54) APPARATUS AND METHOD FOR PROCESSING THREE DIMENSIONAL IMAGE

(71) Applicant: QUANTA COMPUTER INC., Taoyuan City (TW)

(72) Inventors: Yu-Cheng CHIEN, Taoyuan City (TW); Kai-Ju CHENG, Taoyuan City (TW); Chung Sheng WU, Taoyuan City (TW)

(21) Appl. No.: 15/962,407

(22) Filed: Apr. 25, 2018

(30) Foreign Application Priority Data
Jan. 25, 2018 (TW) 107102788

(51) Int. Cl. G06T 17/00; G06T 5/50; H04N 13/218

(52) U.S. Cl. CPC G06T 17/00; G06T 2207/20212; H04N 13/218; G06T 5/50

(57) ABSTRACT

The present disclosure relates to a three-dimensional (3D) scanning apparatus and a 3D modeling method. The 3D scanning apparatus includes an image capture element and a processor. The image capture element is configured to capture multiple sets of images of an object. The processor is configured to obtain image information of a first set of image and image information of an N^{th} set of image of the captured images of the object, compare the image information of the first set of image and the image information of the N^{th} set of image to obtain corresponding information between the first set of image and the N^{th} set of image, and determine whether the corresponding information between the first set of image and the N^{th} set of image is greater than a threshold. If the corresponding information between the first set of image and the N^{th} set of image is greater than the threshold, the processor is configured to combine the first set of image and the N^{th} set of image. N is an integer greater than or equal to 2.

### BACKGROUND OF THE INVENTION

### 1. Field of the Invention

The present disclosure relates to an apparatus and a method for processing a three-dimensional (3D) image, and in particular, to a 3D modeling apparatus and method.

### 2. Description of the Related Art

A 3D scanning apparatus or stereoscopic scanning apparatus is mainly used to scan a to-be-scanned object, so as to obtain space coordinates and information of a surface of the object (properties such as a geometrical structure, a color, and a surface albedo of the object or an environment), and data obtained by the 3D scanning apparatus or stereoscopic scanning apparatus is usually used to perform 3D modeling, so as to construct a 3D model of the to-be-scanned object. The constructed 3D model may be applied to fields such as medical information, industrial design, robot guidance, geomorphic measurement, biological information, criminal identification, and stereoscopic printing.

In some application fields (for example, tooth mold reconstruction), because a viewing angle of a handheld 3D modeling apparatus is relatively small, multiple sets of 3D data at different viewing angles need to be captured, and then the captured 3D data is combined to perform 3D modeling. However, when a user (for example, a dentist or technician) holds a handheld 3D modeling apparatus to perform scanning, speeds of moving the apparatus are not consistent, one problem is that viewing angles of two continuous sets of captured data may be almost consistent (the two sets of captured data overlap excessively) because a movement speed is quite low, so as to greatly reduce a 3D modeling speed; and another problem is that two continuous sets of captured data do not include repetitive locations of the to-be-scanned object (the two sets of captured data do not overlap) because a movement speed is excessively high, so as to generate a relatively large error during combination. Therefore, a 3D scanning apparatus that can perform rapid scanning in high precision is urgently needed.

### SUMMARY OF THE INVENTION

An embodiment of the present disclosure relates to a 3D scanning apparatus. The 3D scanning apparatus includes an image capture element and a processor. The image capture element is configured to capture multiple sets of images of an object. The processor is configured to obtain image information of a first set of image and image information of an N^{th} set of image of the captured images of the object, compare the image information of the first set of image and the image information of the N^{th} set of image to obtain corresponding information between the first set of image and the N^{th} set of image, and determine whether the corresponding information between the first set of image and the N^{th} set of image is greater than a threshold. If the corresponding information between the first set of image and the N^{th} set of image is greater than the threshold, the processor is configured to combine the first set of image and the N^{th} set of image. N is an integer greater than or equal to 2.

Another embodiment of the present disclosure relates to a 3D modeling method. The method includes: (a) capturing multiple sets of images of an object; (b) obtaining image information of a first set of image and image information of an N^{th} set of image of the captured images of the object; (c) comparing the image information of the first set of image and the image information of the N^{th} set of image to obtain corresponding information between the first set of image and the N^{th} set of image; (d) determining whether the corresponding information between the first set of image and the N^{th} set of image is greater than a threshold; and (e) if the corresponding information between the first set of image and the N^{th} set of image is greater than the threshold, combining the first set of image and the N^{th} set of image. N is an integer greater than or equal to 2.

### BRIEF DESCRIPTION OF THE DRAWINGS

The present invention will be described according to the appended drawings in which:

FIG. 1 is a schematic block diagram of a 3D scanning apparatus according to some embodiments of the present disclosure.

FIG. 2 is a flowchart of a 3D modeling method according to some embodiments of the present disclosure.

FIG. 3A to FIG. 3K are a flowchart of a 3D modeling method according to some embodiments of the present disclosure.

### PREFERRED EMBODIMENT OF THE PRESENT INVENTION

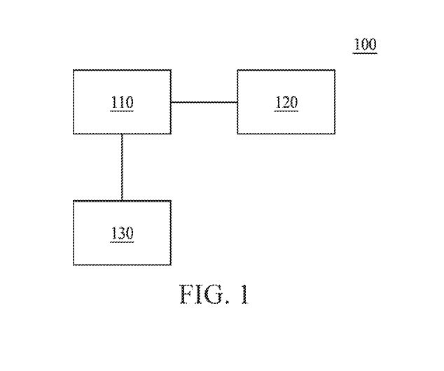

FIG. 1 is a schematic block diagram of a 3D scanning apparatus 100 according to some embodiments of the present disclosure. According to some embodiments of the present disclosure, the 3D scanning apparatus 100 may perform 3D scanning and/or 3D modeling on a stereoscopic object, so as to construct a digital stereoscopic model associated with the stereoscopic object. According to some embodiments of the present disclosure, the 3D scanning apparatus 100 may be further coupled to a 3D printing apparatus (not displayed in the figure), so as to print the constructed 3D model by means of the 3D printing apparatus. As shown in FIG. 1, the 3D scanning apparatus 100 includes an image capture element 110, a controller 120, and a processor 130.

The image capture element 110 is configured to capture information or a feature point of a 3D image of a to-be-scanned object. According to some embodiments of the present disclosure, the captured information or feature point of the 3D image may include but is not limited to a geometrical structure, a color, a surface albedo, a surface roughness, a surface curvature, a surface normal vector, a relative location, and the like of the to-be-scanned object. The image capture element 110 may include one or more lenses or light source modules. The lens of the image capture element 110 may be a fixed-focus lens, a variable-focus lens or a combination thereof. The light source module of the image capture element 110 may be configured to send an even beam, so as to perform illumination compensation in an environment having an insufficient light source. According to some embodiments of the present disclosure, the light source module may be a light emitting diode light source or any other appropriate light source.

The controller 120 is connected to the image capture element 110, and is configured to control the image capture element 110 to capture the information or feature point of the 3D image of the to-be-scanned object. In some embodiments, the controller 120 may have one or more types of sensors that are configured to control the image capture element 110 under a predetermined condition to capture an image. For example, the controller 120 may have an acceleration sensor that is configured to control, when movement of the 3D scanning apparatus 100 is detected, the image capture element 110 to capture an image. For example, the controller 120 may have a location sensor that is configured to control, when the 3D scanning apparatus 100 moves by a predetermined distance, the image capture element 110 to capture an image. For example, the controller 120 may have a timer that is configured to control the image capture element 110 in a predetermined time to capture an image. In some embodiments, the controller 120 may be integrated in the image capture element 110.

The processor 130 is connected to the image capture element 110, and is configured to receive and process the information or feature point that is of the 3D image of the to-be-scanned object and that is captured by the image capture element 110. According to some embodiments of the present disclosure, the information or feature point that is of the 3D image and that is captured by the image capture element 110 may be transferred to the processor 130 by means of wired transmission or wireless transmission (such as Bluetooth, Wi-Fi, or near field communication (NFC)). The processor 130 may have a memory unit (such as a random access memory (RAM) or a flash memory) that is used to store information or feature points that are of one or more sets of 3D images of the to-be-scanned object and that are captured by the image capture element 110. In some embodiments, the memory unit may be an element independent of the processor 130. The processor 130 is configured to combine, after a predetermined quantity of information or feature points of the 3D images of the to-be-scanned object are received, the information or feature points of the 3D images, so as to construct a 3D model of the to-be-scanned object. In some embodiments, the controller 120 may be integrated in the processor 130. In some embodiments, the controller 120 may be omitted, and the processor 130 performs or replaces functions of the controller 120.

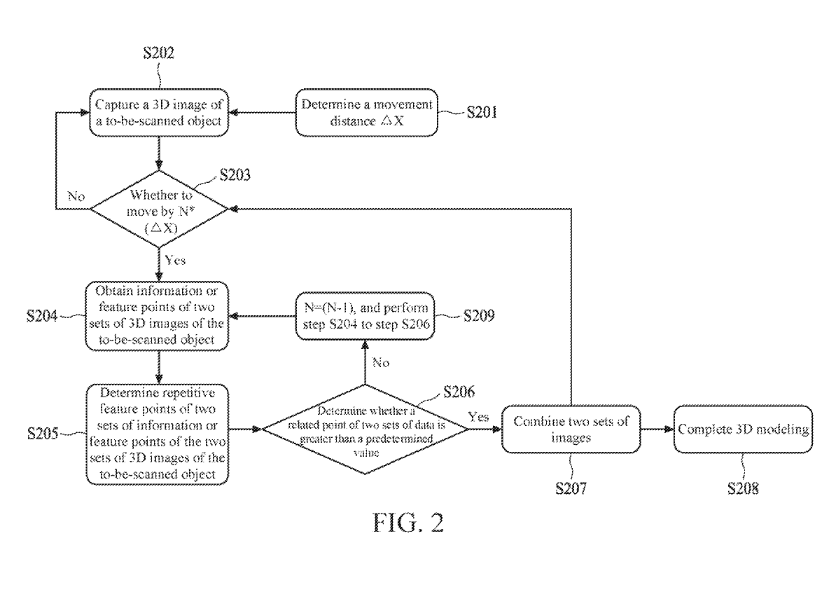

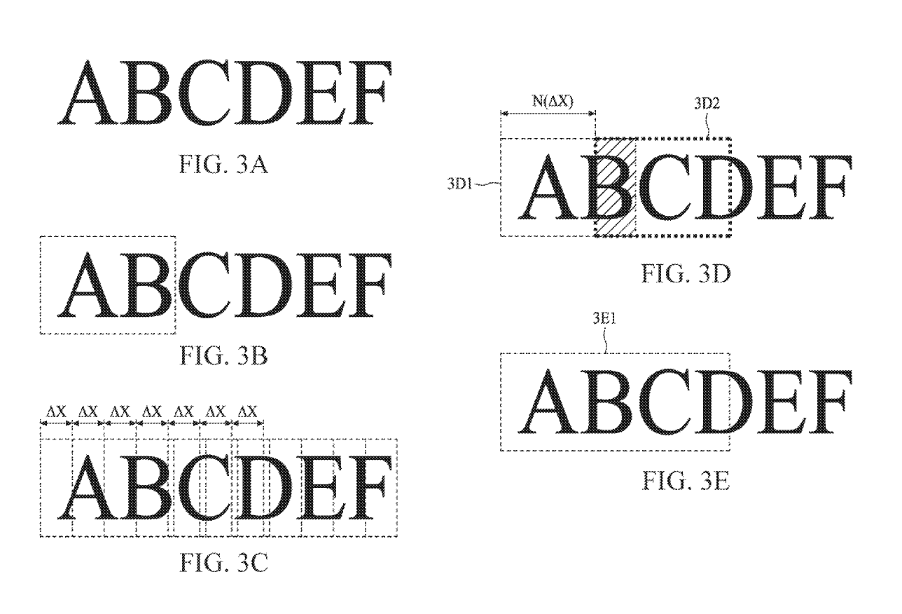

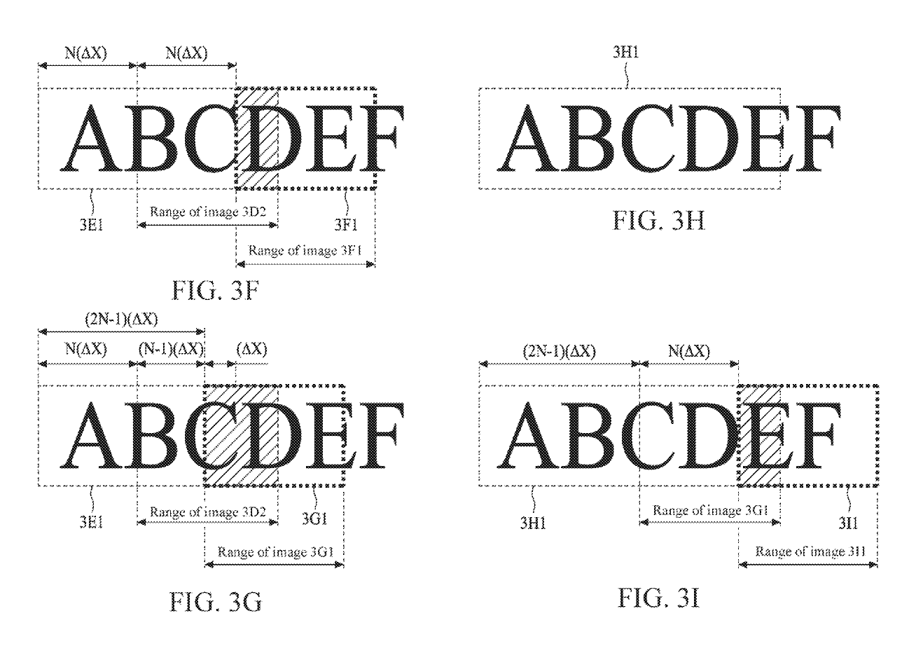

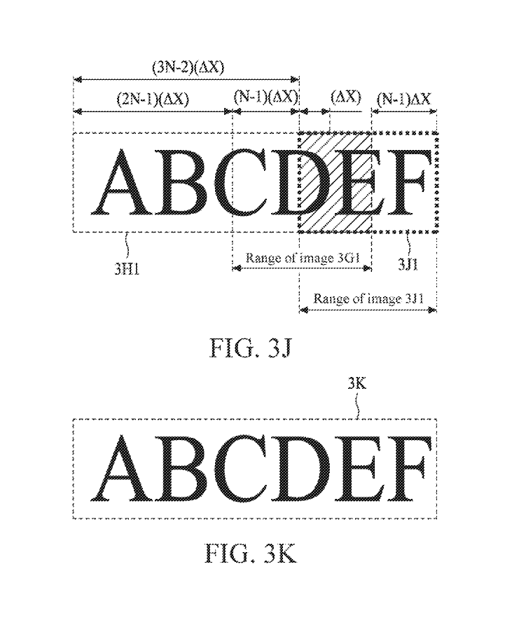

FIG. 2 and FIG. 3A to FIG. 3K are a flowchart of a 3D modeling method according to some embodiments of the present disclosure. According to some embodiments of the present disclosure, the 3D modeling method in FIG. 2 and FIG. 3A to FIG. 3K may be performed by the 3D scanning apparatus 100 in FIG. 1. According to other embodiments of the present disclosure, the 3D modeling method in FIG. 2 and FIG. 3A to FIG. 3K may be performed by another 3D scanning apparatus.

Referring to FIG. 2, first, in step S201, a distance □X by which the 3D scanning apparatus moves each time the 3D scanning apparatus captures a 3D image of a to-be-scanned object (such as a pattern shown in FIG. 3A) is determined. In other words, it is determined that the 3D scanning apparatus captures a 3D image of the to-be-scanned object each time the 3D scanning apparatus moves by the fixed distance □X. According to some embodiments of the present disclosure, the distance □X may be set by the controller 120 shown in FIG. 1. According to other embodiments of the present disclosure, in step S201, the 3D scanning apparatus may also be controlled to capture a 3D image of the to-be-scanned object at an interval of a fixed time or under another predetermined condition.

In a specific embodiment, a distance □X for a 3D image ranges from 1 mm to 2 mm. In a specific embodiment, the fixed time ranges, for example, from 1/30 second to 1/360 second.

Referring to FIG. 2, in step S202, the 3D scanning apparatus captures a 3D image of the to-be-scanned object at an interval of a fixed distance □X. As shown in FIG. 3B and FIG. 3C, a dashed line box in FIG. 3B is a range in which the 3D scanning apparatus captures a 3D image of the to-be-scanned object each time, while FIG. 3C discloses that the 3D scanning apparatus captures a 3D image of the to-be-scanned object at an interval of □X. According to some embodiments of the present disclosure, the 3D scanning apparatus may capture an image by means of the image capture element 110 shown in FIG. 1. According to some embodiments of the present disclosure, the captured image may be stored in a memory of the 3D scanning apparatus 100.

Referring to FIG. 2, in step S203, whether the 3D scanning apparatus moves by a predetermined quantity N of times the distance □X is determined, where N is a positive integer greater than 1 (for convenience of description, it is assumed that N=5). In other words, whether the 3D scanning apparatus moves by a distance of N*(□X) is determined. In other words, whether the 3D scanning apparatus captures N sets of 3D images of the to-be-scanned object is determined. If it is determined that the 3D scanning apparatus has not moved by the predetermined quantity of times the distance □X, step S202 continues to be performed. If it is determined that the 3D scanning apparatus has moved by the predetermined quantity N of times the distance □X, step S204 is performed. According to some embodiments of the present disclosure, step 203 may be determined by means of the controller 120 or the processor 130 shown in FIG. 1. In a specific embodiment, the predetermined quantity N ranges, for example, from 3 to 5.

Referring to FIG. 2, in step S204, information or feature points of two sets of captured 3D images of the to-be-scanned object are obtained. In a preferable embodiment, the information or feature points of the two sets of 3D images include information or a feature point of a first set of captured 3D image and information or a feature point of an N^{th} set of captured 3D image. Using FIG. 3D as an example, the first set of 3D image of the to-be-scanned object is 3D1 and the N^{th} set of 3D image is 3D2. According to some embodiments of the present disclosure, the information or feature points of the two sets of 3D images of the to-be-scanned object may be obtained by the image capture element 110 or the processor 130 shown in FIG. 1.

Referring to FIG. 2, in step S205, the information or feature points of the two sets of 3D images of the to-be-scanned object are compared, and a part in which the two sets of information or feature points overlap or are related is calculated. For example, two sets of obtained geometrical structures, colors, surface albedos, surface roughnesses, surface curvatures, surface normal vectors, relative locations, and the like of the to-be-scanned object are compared, and a part that is common or related to them is calculated. Using FIG. 3D as an example, the information or feature points of the two sets of 3D images 3D1 and 3D2 of the to-be-scanned object are compared, and feature points that are common or related to them are a middle overlapping part (shown by oblique lines). According to some embodiments of the present disclosure, by means of the processor 130 shown in FIG. 1, the information or feature points of the two sets of 3D images of the to-be-scanned object may be compared, and a part in which the two sets of information or feature points overlap or are related is calculated.

Referring to FIG. 2, in step S206, whether a part in which the two sets of information or feature points of the 3D images of the to-be-scanned object overlap or are related is greater than a predetermined value is determined. According to some embodiments of the present disclosure, the predetermined value is a threshold for determining whether the two sets of information have sufficient common or related feature points that can be used to combine images. For example, the threshold may be a minimum value of a quantity of corresponding information or feature points needed for being capable of successfully combining two sets of images. According to some embodiments of the present disclosure, whether the part in which the two sets of information or feature points overlap or are related is greater than the predetermined value may be determined by means of the processor 130 shown in FIG. 1. In a specific embodiment, a minimum value of the threshold is 10. That is, the minimum value of the quantity of the corresponding information or feature points needed for being capable of successfully combining two sets of images is 10.

Referring to FIG. 2, in step S207, if the part in which the information or feature points of the two sets of 3D images of the to-be-scanned object overlap or are related is greater than a predetermined value, the two sets of 3D images of the to-be-scanned object are combined. For example, if the middle overlapping part of the two sets of 3D images 3D1 and 3D2 of the to-be-scanned object in FIG. 3D is greater than the predetermined value, the two sets of 3D images 3D1 and 3D2 of the to-be-scanned object are combined, as shown in FIG. 3E, so as to complete 3D modeling 3E1 of a first part of the to-be-scanned object. According to some embodiments of the present disclosure, the two sets of 3D images of the to-be-scanned object may be combined by means of the processor 130 shown in FIG. 1.

After the 3D modeling of the first part of the to-be-scanned object is completed, the method returns to step S203, and whether the 3D scanning apparatus moves by the distance of N*(□X) again (that is, away from the original point by a distance of 2N*(□X)) is determined. Then, step S204 continues to be performed, and the information or feature points of the two sets of captured 3D images of the to-be-scanned object are obtained again. For example, the information or feature point of the N^{th} set of previously captured 3D image of the to-be-scanned object and information or a feature point of a 2N^{th} set of 3D image are obtained. Using FIG. 3F as an example, the N^{th} set of image of the 3D images of the to-be-scanned object is 3D2 (the N^{th} set of image 3D2 and the first set of image 3D1 are combined into 3E1) and the 2N^{th} set of image is 3F1. Then, referring to step S205, the information or feature points of the two sets of 3D images of the to-be-scanned object are compared, and the part in which the two sets of information or feature points overlap or are related is calculated. In step S206, whether a part in which the two sets of information or feature points of the 3D images of the to-be-scanned object overlap or are related is greater than a predetermined value is determined. If the part in which the information or feature points of the two sets of 3D images of the to-be-scanned object overlap or are related is greater than a predetermined value, the two sets of 3D images of the to-be-scanned object are combined. Then, step S203 to step S207 are continuously repeated until the 3D modeling of the to-be-scanned object is completed.

Referring to FIG. 2, in step S209, if the part in which the information or feature points of the two sets of 3D images of the to-be-scanned object overlap or are related is less than the predetermined value, it is determined that the two sets of 3D images of the to-be-scanned object have no sufficient common or related feature points that can be used to combine images, then, let N=N−1 (in this case, new N=4), and step S204 to step S206 are again performed.

Using FIG. 3F and FIG. 3G as an example, when common or related feature points (a part shown by oblique lines) of the previous N^{th} set of image 3D2 (the N^{th} set of image 3D2 and the first set of image 3D1 are combined into 3E1) and the 2N^{th} set of image 3F1 of the 3D images of the to-be-scanned object are less than the predetermined value, let N=N−1, and then the originally determining common or related feature points of the N^{th} set of image 3D2 and the 2N^{th} set of image 3F1 is changed to determining common or related feature points of the N^{th} set of image 3D2 and the (2N−1)^{th} set of image 3G1. Then, referring to FIG. 3H, if common or related feature points of the N^{th} set of image 3D2 and the (2N−1)^{th} set of image 3G1 of the 3D images of the to-be-scanned object are greater than the predetermined value, the image 3E1 previously obtained by combining the images 3D1 and 3D2 and the (2N−1)^{th} set of image 3G1 are combined, so as to complete 3D modeling 3H1 of a second part of the to-be-scanned object (such as step S207), and an original value of N is restored (in this case, N=5).

After the 3D modeling of the second part of the to-be-scanned object is completed, the method returns to step S203 again, and whether the 3D scanning apparatus moves by the distance of N*(□X) again is determined. Then, step S204 continues to be performed, and the information or feature points of the two sets of captured 3D images of the to-be-scanned object are obtained again. Using FIG. 3I as an example, among the 3D images of the to-be-scanned object, the (2N−1)^{th} set of image is 3G1 (the (2N−1)^{th} set of image 3G1 and the image 3E1 are combined into 3H1) and the (3N−1) (that is, (2N−1)+N)^{th} set of image is 3I1. Then, referring to step S205, the information or feature points of the two sets of 3D images of the to-be-scanned object are compared, and the part in which the two sets of information or feature points overlap or are related is calculated. In step S206, whether a part in which the two sets of information or feature points of the 3D images of the to-be-scanned object overlap or are related is greater than a predetermined value is determined. If the part in which the information or feature points of the two sets of 3D images of the to-be-scanned object overlap or are related is greater than a predetermined value, the two sets of 3D images of the to-be-scanned object are combined. Then, step S203 to step S207 are continuously repeated until the 3D modeling of the to-be-scanned object is completed.

If the part in which the information or feature points of the two sets of 3D images of the to-be-scanned object overlap or are related is less than the predetermined value, it is determined that the two sets of 3D images of the to-be-scanned object have no sufficient common or related feature points that can be used to combine images, then, let N=N−1 (in this case, new N=4), and step S204 to step S206 are again performed. Using FIG. 3I and FIG. 3J as an example, when common or related feature points (a part shown by oblique lines) of the (2N−1)^{th} set of image 3G1 (the (2N−1)^{th} set of image 3G1 and the image 3E1 are combined into 3H1) and the (3N−1)^{th} set of image 3I1 of the 3D images of the to-be-scanned object are less than the predetermined value, let N=N−1, and then the originally determining common or related feature points of the (2N−1)^{th} set of image 3G1 and the (3N−1)^{th} set of image 3I1 is changed to determining common or related feature points of the (2N−1)^{th} set of image 3G1 and the (3N−2)^{th} set of image 3J1. As shown in FIG. 3K, if common or related feature points of the (2N−1)^{th} set of image 3G1 and the (3N−2)^{th} set of image 3J1 of the 3D images of the to-be-scanned object are greater than the predetermined value, the image 3H1 and the (3N−2)^{th} set of image 3J1 are combined, so as to complete 3D modeling 3K of a third part of the to-be-scanned object.

Referring to FIG. 2, in step S209, after 3D modeling of all parts of the to-be-scanned object ends, the 3D modeling of the to-be-scanned object is completed, so as to reconstruct the to-be-scanned object.

In some embodiments, if all images of the to-be-scanned object that are captured by the 3D scanning apparatus are combined (such as an embodiment in which N=1), for example, the first set of image and the second set of image are combined, the second set of image and the third set of image are combined, and the rest can be deduced by analogy, although it may be ensured that each combination may be successful, the processor needs to perform a large quantity of operations during image combination, so as to greatly reduce operation efficiency and a 3D modeling speed of the 3D scanning apparatus.

According to the embodiment in FIG. 2 and FIG. 3A to FIG. 3K of the present disclosure, the 3D scanning apparatus is operated with the setting in which N is greater than 1 (that is, an integer 2 or greater than 2). If related or common feature points of two sets of image data are less than a threshold, the 3D scanning apparatus is operated with the setting of (N−1).

In this way, image combination correctness may be ensured, and combination may be performed in a minimum overlapping area (that is, the related or common feature points of the two sets of image data are closest to the threshold), so as to reduce a quantity of combination times, and then improve the operation efficiency and the 3D modeling speed of the 3D scanning apparatus.

Although the technical contents and features of the present invention are described above, various variations and modifications can be made by persons of ordinary skill in the art without departing from the teaching and disclosure of the present invention. Therefore, the scope of the present invention is not limited to the disclosed embodiments, but encompasses other variations and modifications that do not depart from the present invention as defined by the appended claims.

The above-described embodiments of the present invention are intended to be illustrative only. Numerous alternative embodiments may be devised by persons skilled in the art without departing from the scope of the following claims.

What is claimed is:

1. A three-dimensional (3D) scanning apparatus, comprising:
an image capture element, configured to capture multiple sets of images of an object; and
a processor, configured to obtain image information of a first set of image and image information of an N^{th} set of image of the captured images of the object, compare the image information of the first set of image and the image information of the N^{th} set of image to obtain corresponding information between the first set of image and the N^{th} set of image, and determine whether the corresponding information between the first set of image and the N^{th} set of image is greater than a threshold, wherein
if the corresponding information between the first set of image and the N^{th} set of image is greater than the threshold, the processor is configured to combine the first set of image and the N^{th} set of image, wherein N is an integer greater than or equal to 2.

2. The 3D scanning apparatus according to claim 1, wherein if the corresponding information between the first set of image and the N^{th} set of image is less than the threshold, the processor is configured to compare the image information of the first set of image and image information of a (N−1)^{th} set of image of the captured images of the object to obtain corresponding information between the first set of image and the (N−1)^{th} set of image.

3. The 3D scanning apparatus according to claim 2, wherein if the corresponding information between the first set of image and the (N−1)^{th} set of image is greater than the threshold, the processor is configured to combine the first set of image and the (N−1)^{th} set of image.

4. The 3D scanning apparatus according to claim 2, wherein N is an integer greater than or equal to 3.

5. The 3D scanning apparatus according to claim 1, wherein the image information of the first set of image or the image information of the N^{th} set of image comprises at least one of the following of the object or a combination thereof: a geometrical structure, a color, a surface albedo, a surface roughness, a surface curvature, a surface normal vector, and a relative location.

6. The 3D scanning apparatus according to claim 1, wherein the threshold is a minimum value of a quantity of corresponding information of needed for being capable of successfully combining the first set of image and the N^{th} set of image.

7. The 3D scanning apparatus according to claim 1, wherein the processor is configured to control the image capture element to capture an image of the object each time the image capture element moves by a predetermined distance.

8. The 3D scanning apparatus according to claim 1, wherein the processor is configured to control the image capture element to capture an image of the object at an interval of a predetermined time.

9. A 3D modeling method, wherein the method comprises:
(a) capturing multiple sets of images of an object;
(b) obtaining image information of a first set of image and image information of an N^{th} set of image of the captured images of the object;
(c) comparing the image information of the first set of image and the image information of the N^{th} set of image to obtain corresponding information between the first set of image and the N^{th} set of image;
(d) determining whether the corresponding information between the first set of image and the N^{th} set of image is greater than a threshold; and
(e) if the corresponding information between the first set of image and the N^{th} set of image is greater than the threshold, combining the first set of image and the N^{th} set of image, wherein
N is an integer greater than or equal to 2.

10. The method according to claim 9, further comprising: if the corresponding information between the first set of image and the N^{th} set of image is less than the threshold,
comparing the image information of the first set of image and image information of a (N−1)^{th} set of image of the captured images of the object to obtain corresponding information between the first set of image and the (N−₁)^{th} set of image; and
determining whether the corresponding information between the first set of image and the (N−1)^{th} set of image is greater than the threshold.

11. The method according to claim 10, further comprising: if the corresponding information between the first set of image and the (N−1)^{th} set of image is greater than the threshold, combining the first set of image and the (N−1)^{th} set of image.

12. The method according to claim 11, wherein N is an integer greater than or equal to 3.

13. The method according to claim 9, wherein the image information of the first set of image or the image information of the N^{th} set of image comprises at least one of the following of the object or a combination thereof: a geometrical structure, a color, a surface albedo, a surface roughness, a surface curvature, a surface normal vector, and a relative location.

14. The method according to claim 9, wherein the threshold is a minimum value of a quantity of corresponding information of needed for being capable of successfully combining the first set of image and the N^{th} set of image.

15. The method according to claim 9, wherein step (a) further comprises: capturing an image of the object at an interval of a predetermined distance.

16. The method according to claim 9, wherein before step (b), the method further comprises: determining whether a quantity of the captured images of the object is greater than or equal to N.

17. The method according to claim 16, further comprising: if the quantity of the captured images of the object is less than N, continuing to capture images of the object until a quantity of captured images of the object is greater than or equal to N.
